(19) United States
(12) Patent Application Publication
(10) Pub. No.: US 2006/0210156 A1
(43) Pub. Date: Sep. 21, 2006

(54) VIDEO COMPRESSION FOR RAW RGB FORMAT USING RESIDUAL COLOR TRANSFORM

(75) Inventors: Shawmin Lei, Camas, WA (US); Shijun Sun, Vancouver, WA (US)

Correspondence Address: SHARP LABORATORIES OF AMERICA, INC, 5750 NW PACIFIC RIM BLVD, CAMAS, WA, 98642, US

(73) Assignee: SHARP LABORATORIES OF AMERICA, INC., Camas, WA (US)

(21) Appl. No.: 10/907,082

(22) Filed: Mar. 18, 2005

(51) Int. Cl. G06K 9/00; G06K 9/36

(52) U.S. Cl. 382/166; 382/232

(57) ABSTRACT

A Residual Color Transform (RCT) technique directly encodes raw Red-Green-Blue (RGB) data directly without first performing a color transform. After transmission or storage, the coded raw RGB data is directly decoded and then interpolated to generate missing RGB data.

### CROSS-REFERENCE TO RELATED APPLICATION

The present patent application is related to U.S. patent application entitled “Residual Color Transform for 4:2;0 RGB Format,” invented by Shijun Sun, Ser. No. ______ (Attorney Docket No. SLA1786), which is filed concurrently herewith and incorporated by reference herein.

### BACKGROUND OF THE INVENTION

1. Field of the Invention

The present invention relates to video coding. In particular, the present invention relates to a system and a method for encoding Red-Green-Blue (RGB) video data.

2. Description of the Related Art

Residual Color Transform (RCT) is a coding tool for the H.264 High 4:4:4 profile that is intended for efficient coding of video sequences in a Red-Green-Blue-format (RGB-format). FIGS. 1 and 2 illustrate the difference between a conventional video coding system that does not use the RCT coding tool and a conventional video coding system that uses the RCT coding tool. Details regarding the encoding and decoding loops, and the prediction and compensation loops are not shown in either of FIG. 1 or 2.

FIG. 1, in particular, depicts a high-level functional block diagram of a conventional video coding system 100 that does not use the RCT coding tool. Conventional video coding system 100 captures Red-Green-Blue (RGB) data in a well-known manner at 101. At 102, the RGB data is converted into a YCbCr (or YCoCg) format. At 103, intra/inter prediction is performed on the YCbCr-formatted (or YCoCg-formatted) data. A spatial transform is performed at 104 and quantization is performed at 105. Entropy encoding is performed at 106. The encoded data is transmitted and/or stored, as depicted by channel/storage 107. At 108, the encoded data is entropy decoded. At 109, the entropy-decoded data is dequantized. An inverse-spatial transform is performed at 110, and intra/inter compensation is performed at 111. At 112, the resulting YCbCr-formatted (or YCoCg-formatted) data is transformed to RGB-based data and displayed at 113.

FIG. 2 depicts a high-level functional block diagram of a conventional video coding system 200 that uses the RCT coding tool for the H.264 High 4:4:4 profile. Video coding system 200 captures RGB data in a well-known manner at 201. At 202, intra/inter prediction is performed on the RGB data. At 203, the intra/inter-predicted data is converted into a YCbCr (or YCoCg) format. A spatial transform is performed at 204 and quantization is performed at 205. Entropy encoding is performed at 206. The encoded data is transmitted and/or stored, as depicted by channel/storage 207. At 208, the encoded data is entropy decoded. At 209, the entropy-decoded data is dequantized. An inverse-spatial transform is performed on YCbCr-formatted (or YCoCg-formatted) data at 210. At 211, the YCbCr-based data is transformed to RGB-based data. At 212, intra/inter compensation is performed, and RGB-based data is displayed at 213.

The difference between conventional video coding system 100 (FIG. 1) and conventional video coding system 200 (FIG. 2) is that the RCT coding tool of system 200 enables compression and decompression directly to and from the RGB space. To illustrate this, compression directly in the RGB space is depicted in FIG. 2 by the sequence of functional blocks 202-204. In particular, intra/inter prediction is performed on the RGB data at 202. The intra/inter-predicted data is converted into a YCbCr (or YCoCg) format at 203. A spatial transform is then performed at 204. Decompression directly from the RGB space is depicted in FIG. 2 by the sequence of functional blocks 210-212. At 210, an inverse-spatial transform is performed on YCbCr-formatted (or YCoCg-formatted) data at 210. At 211, the YCbCr-formatted data is transformed to RGB-based data. At 212, intra/inter compensation is performed at 111.

In contrast, the corresponding compression process in conventional video coding system 100 is depicted by functional blocks 102-104. At 102, RGB data is converted into a YCbCr (or YCoCg) format. Intra/inter prediction is performed on the YCbCr-formatted (or YCoCg-formatted) data at 103, and a spatial transform is performed at 104. The corresponding decompression process is depicted by functional blocks 110-112 in which an inverse spatial transform is performed at 110. Intra/inter compensation is performed at 111. Lastly, the YCbCr (or YCoCg) data is transformed to RGB-based data at 112.

The color conversion in RCT at 203 in FIG. 2, as an RGB-based format to a YCoCg-based format, is inside a typical coding loop, and can be considered as an extension of a conventional transform coding from a 2D spatial transform to a 3D transform (2D spatial+1D color), but, with the same purpose of all transform coding, that is, data decorrelation and energy compaction and, consequently, easier compression. Significant improvements in rate distortion performance over a conventional coding scheme have been achieved for all three RGB color components, as demonstrated in an updated version of the RCT algorithm.

The main challenge for RCT, as RCT is applied in practice, does not related to compression, but relates to video capture and display. Moreover, the outputs of most video-capture devices currently do not support the RGB format not because extra hardware and software resources are needed internally to convert data from RGB-based data but based on the bandwidth requirements for the 4:4:4 RGB format.

For a single-chip-color-sensor digital video camera, each pixel actually has only one color component. FIG. 3A depicts a typical Bayer mosaic filter 300, which is used for most of the popular primary-color-mosaic sensors. As depicted in FIG. 3A, the Green (G) sensors, or filters, cover 50% of the pixels, while the Blue (B) and Red (R) sensors, or filters, each cover 25% of the pixels. Because each pixel position has only one color component, the other two color components must be interpolated, or generated, based on existing samples. The interpolation process is a simple 1:3 data expansion.

FIG. 4 depicts a high-level functional block diagram of a conventional video coding system 400 that provides a lossy color conversion, such as from RGB to YCbCr. At 401, RGB sensors perform RGB capture. At 402, a 1:3 interpolation process is performed for generating missing color components. At 403, color conversion and a lossy 2:1 subsampling is performed for generating 4:2:0 YCbCr data. Thus, the overall process up to functional block 404 results in a lossy 1:1.5 data expansion before the 4:2:0 YCbCr data is compressed, i.e., video coded. The encoded data is transmitted and/or stored, as depicted by channel/storage 405. The video coded data is then decoded at 406. Color up-sampling and color conversion occurs at 407, and the resulting data is RGB displayed at 408.

What is needed is a residual color transformation (RCT) coding tool for raw RGB data in which compression is performed directly on the raw RGB data without data loss prior to compression.

### SUMMARY OF THE INVENTION

The present invention provides a residual color transformation (RCT) coding technique for raw RGB data in which compression is performed directly on raw RGB data without first performing a color transform.

The present invention provides a Residual Color Transform (RCT) coding method for encoding Red-Green-Blue (RGB) data comprising video coding raw RGB data using an RCT coding tool. The video coding of raw RGB data encodes the raw RGB data directly without first performing a color transform. After transmission or storage, the coded raw RGB data is directly decoded. The decoded raw RGB data is then interpolated to generate at least one of a missing Red color component, a missing Green color component and a missing Blue color component.

One exemplary embodiment of the present invention provides a closed-loop coding technique in which two 4×4 Green residuals are sub-sampled to form a single 4×4 Green residual. The single 4×4 Green residual, a corresponding 4×4 Red residual and a corresponding 4×4 Blue residual are converted to YCoCg-based data. The YCoCg-based data is 4×4 transformed and quantized to form YCoCg coefficient. The YCoCg coefficients are then coded into a bitstream.

For this exemplary embodiment, coding the YCoCg coefficients into the bitstream includes dequantizing the YCoCg coefficients and 4×4 inverse transforming the dequantized YCoCg coefficients to reconstruct the YCoCb-based data. The YCoCg-based data is converted to RGB-based data and 4×4 G residual data is reconstructed. The 4×4 G residual data is up-sampled to form two interleaved 4×4 G residual prediction blocks. Two 2nd-level interleaved 4×4 Green residuals are formed based on a difference between the two interleaved 4×4 G residual prediction blocks and the two interleaved 4×4 Green residual blocks. The two 2nd-level 4×4 Green residuals are 4×4 transformed. The two transformed 2nd-level 4×4 Green residuals are quantized to form Green coefficients that are coded into the bitstream.

The present invention also provides a method for decoding the bitstream to form YCoCg coefficients in which the YCoCg coefficients are de-quantized to form de-quantized YCoCg coefficients. The de-quantized YCoCg coefficients are inverse-transformed to form YCoCg-based data. The YCoCg-based data are YCoCg-to-RGB converted to form a reconstructed 4×4 Green residual, a corresponding reconstructed 4×4 Red residual and a corresponding reconstructed 4×4 Blue residual. The reconstructed 4×4 Green residual is up-sampled to form two interleaved reconstructed 4×4 Green residual predictions. Forming two interleaved reconstructed 4×4 Green residuals includes decoding the bitstream to form 2nd-level Green coefficients, de-quantizing the 2nd-level Green coefficients to form de-quantized 2nd-level Green coefficients, inverse-transforming the de-quantized 2nd-level Green coefficients to form two interleaved 2nd-level 4×4 Green residuals, and combining the two 2nd-level 4×4 Green residuals with the two interleaved reconstructed 4×4 Green residual predictions to form the two reconstructed 4×4 Green residuals.

Another exemplary embodiment provides an open-loop coding technique in which two interleaved 4×4 blocks of Green prediction residuals are Haar transformed to form an averaged 4×4 G residual and a differenced 4×4 G residual. The averaged 4×4 Green residual, a corresponding 4×4 Red residual and a corresponding 4×4 Blue residual are converted to YCoCg-based data. The YCoCg-based data is 4×4 transformed and then quantized to form YCoCg coefficients. The YCoCg coefficients are coded into a bitstream.

For this exemplary embodiment, coding the YCoCg coefficients into the bitstream includes transforming and then quantizing the differenced 4×4 G residual to form Green coefficients. The Green coefficients are then entropy coded into the bitstream.

The present invention also provides a method for decoding the bitstream to form YCoCg coefficients. The YCoCg coefficients are de-quantized to form de-quantized YCoCg coefficients. The de-quantized YCoCg coefficients are inverse-transformed to form YCoCg-based data. The YCoCg-based data are YCoCg-to-RGB converted to form a reconstructed 4×4 Green residual, a corresponding reconstructed 4×4 Red residual and a corresponding reconstructed 4×4 Blue residual. Two reconstructed interleaved 4×4 Green residuals are formed from the reconstructed 4×4 Green residual. Forming two reconstructed interleaved 4×4 Green residuals includes decoding the bitstream to form 2nd-level Green coefficients, de-quantizing the 2nd-level Green coefficients to form de-quantized 2nd-level Green coefficients, inverse-transforming the de-quantized 2nd-level Green coefficients to form a 2nd-level 4×4 Green residual, and inverse-Haar transforming the 2nd-level 4×4 Green residual with the reconstructed 4×4 Green residual to form the two interleaved reconstructed 4×4 Green residuals.

### BRIEF DESCRIPTION OF THE DRAWINGS

The present invention is illustrated by way of example and not by limitation in the accompanying figures in which like reference numerals indicate similar elements and in which:

FIG. 1 depicts a high-level functional block diagram of a conventional video coding system that does not use the RCT coding tool;

FIG. 2 depicts a high-level functional block diagram of a conventional video coding system that uses the RCT coding tool for the H.264 High 4:4:4 profile;

FIG. 3A depicts a typical Bayer mosaic filter, which is used for most of the popular primary-color-mosaic sensors;

FIG. 3B depicts two exemplary interleaved 4×4 G residuals, an exemplary 4×4 B residual and an exemplary 4×4 R residual;

FIG. 4 depicts a high-level functional block diagram of a conventional video coding system that provides a lossy color conversion, such as from RGB to YCbCr;

FIG. 5 depicts a high-level block diagram of a video coding system according to the present invention;

FIG. 6 shows a flow diagram of a closed-loop residual encoding technique using RCT for raw RGB data according to the present invention;

FIG. 7 shows a flow diagram of a closed-loop residual decoding technique using RCT for raw RGB data according to the present invention;

FIG. 8 shows a flow diagram of an open-loop residual encoding technique using RCT for raw RGB data according to the present invention; and

FIG. 9 shows a flow diagram of an open-loop residual decoding technique using RCT for raw RGB data according to the present invention.

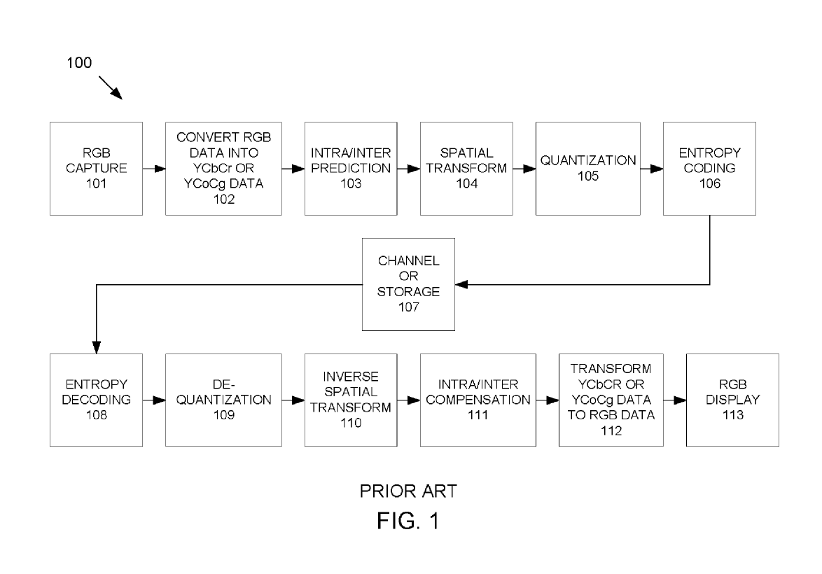

### DETAILED DESCRIPTION OF THE PRESENT INVENTION

The present invention provides a Residual Color Transform (RCT) coding tool for raw RGB data in which compression is performed directly on raw RGB data directly without first performing a color transform first.

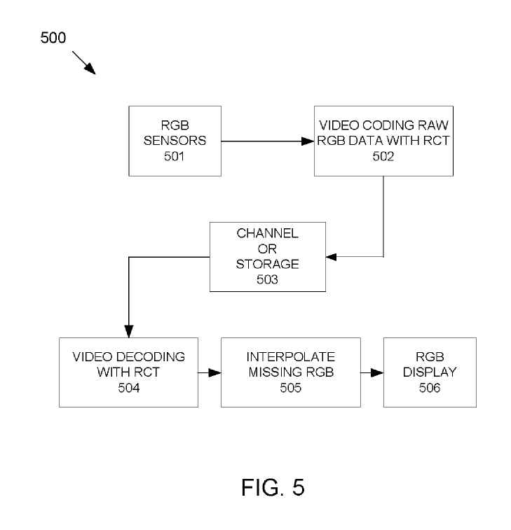

FIG. 5 depicts a high-level block diagram of a video coding system according to the present invention. In particular, RGB sensors perform RGB capture in a well-known manner at 501. The encoding process at 502 operates directly on the raw RGB data using the RCT coding tool. The sampling positions of the RGB data are different within each pixel and the positions can change from picture to picture. Consequently, in one exemplary embodiment of the present invention the RGB sampling positions are signaled in the bitstream at sequence and/or each picture and are then used for motion-vector interpolation and final display rendering (i.e., interpolation of missing RGB data). For example, a zero-motion motion compensation for R/B might actually correspond to a non-zero motion in G.

The encoded raw RGB data is then transmitted and/or stored, as depicted by channel/storage 503. The decoding process operates directly on the RGB data at 504. At 505, interpolation is performed for generating RGB color components. The resulting data is RGB displayed at 506.

Interpolation for the RGB color components (functional block 505) is deferred in the present invention until the bitstreams have been decoded. Additionally, it should be noted that the RGB color component interpolation (functional block 505) could be part of a post-processing for video decoding at 504 or part of a preprocessing for RGB display at 506.

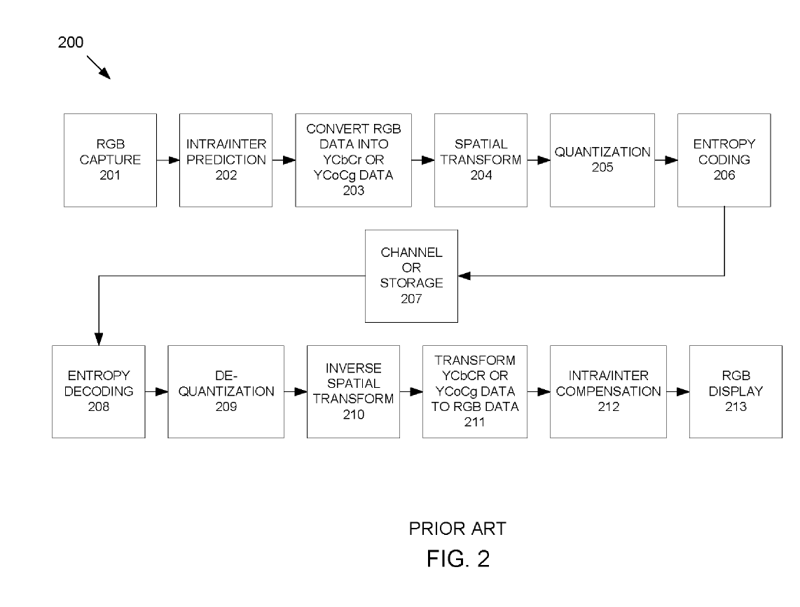

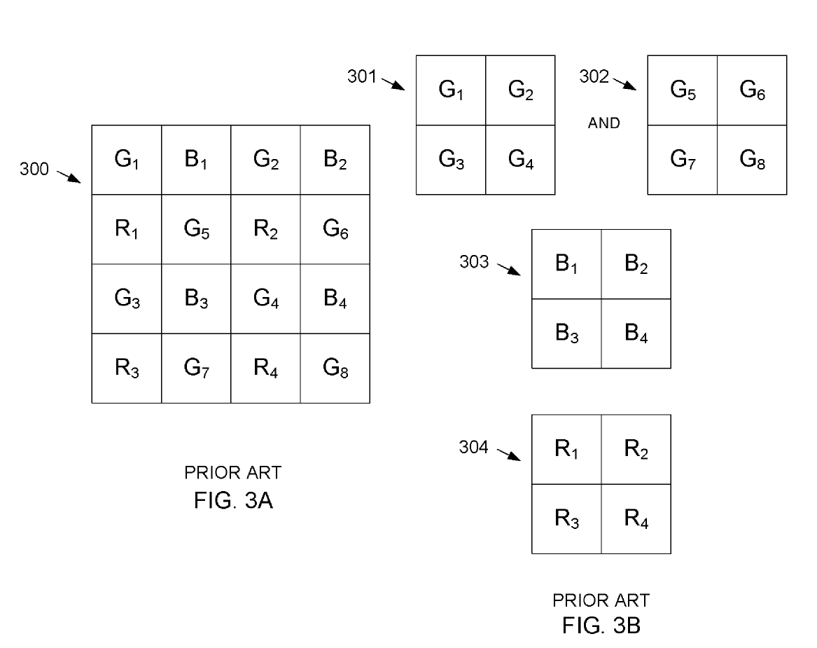

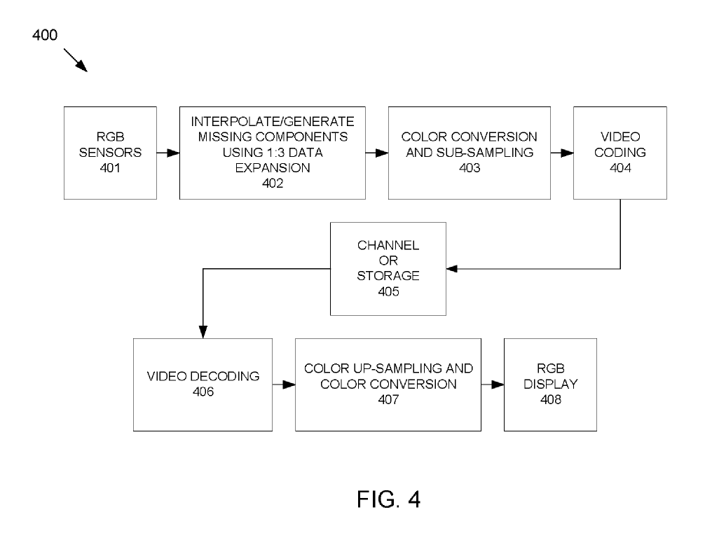

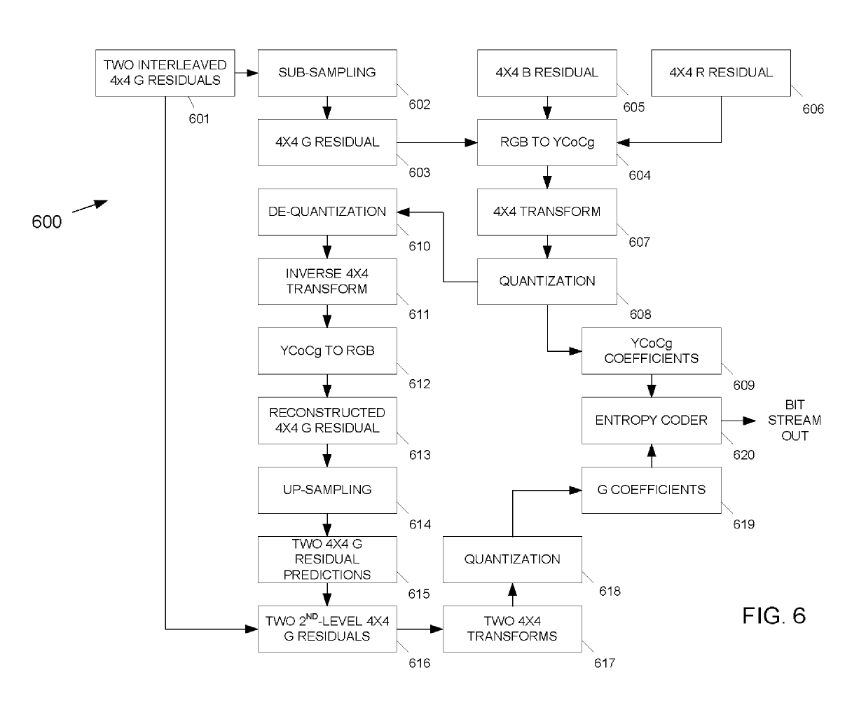

FIG. 6 shows a flow diagram 600 of a closed-loop residual encoding technique according to the present invention using RCT for raw RGB data. Flow diagram 600 corresponds to the second part of processes that occur in block 502 in FIG. 5, which also includes as its first part of processes Intra/Inter Prediction, which is similar to block 202 in FIG. 2 except that the Prediction is done in the present invention based on raw RGB data, not on grid-pattern RGB data. Thus, the process depicted in FIG. 6 corresponds only to the residual coding, including transforms (spatial and RCT), quantization, and entropy coding modules. Prediction and motion compensation are done in the raw RGB domain and are not depicted in FIG. 6. Block 601 in FIG. 6 represents two interleaved 4×4 blocks of Green (G) prediction residuals. FIG. 3B depicts two exemplary interleaved 4×4 G residuals 301 and 302, an exemplary 4×4 B residual 303 and an exemplary 4×4 R residual 304. At block 602, the two interleaved 4×4 blocks of G prediction residuals is sub-sampled to produce a 4×4 block of G residual at block 603. The sub-sampling at block 602 could be, for example, an averaging operation. Alternatively, any low-pass or decimation filtering technique could be used for block 602. At block 604, the 4×4 G residual together with the 4×4 Blue (B) residual (block 605) and the 4×4 block of Red (R) residual (block 606) are converted from RGB-based data to YCoCg-based data (in three 4×4 blocks). At block 607, the YCoCg data goes through a 4×4 transformation and is quantized at block 608 to produce YCoCg coefficients at block 609. The YCoCg coefficients are coded into bitstreams by an entropy encoder at block 620.

The YCoCg coefficients generated at block 608 are dequantized at block 610 and inverse 4×4 transformed at block 611 to reconstruct the YCoCg-based data before being converted to RGB-based data at block 612 to form a reconstructed 4×4 G residual at block 613. The 4×4 G residual is up-sampled at block 614 to form two interleaved 4×4 G residual predictions at block 615. The up-sampling process at block 614 could be, for example, a duplicative operation. Alternatively, any interpolation filtering technique could be used for block 614. The differences between the two interleaved 4×4 G residuals at block 601 and the two interleaved 4×4 G residual predictions at block 615 are used to form the two 2nd-level 4×4 G residuals at block 616. The two 2nd-level 4×4 G residuals go through two 4×4 transformations at 617 and a quantization process at block 618 to form Green (G) coefficients at block 619. The G coefficients are coded into bitstreams by the entropy coder at block 620.

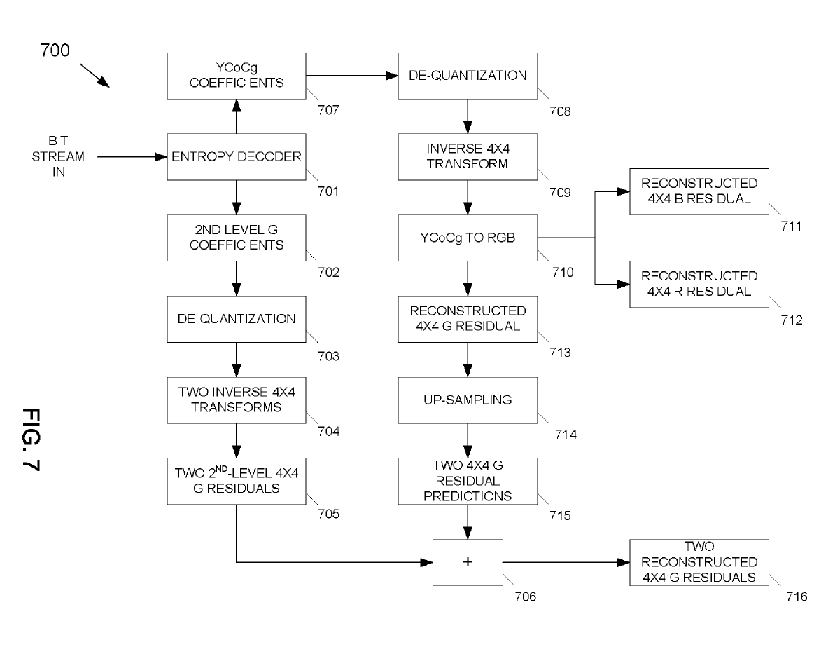

FIG. 7 shows a flow diagram 700 of a closed-loop residual decoding technique using RCT for raw RGB data according to the present invention, which is a decoder corresponding to the residual encoding technique of FIG. 6. The process depicted in FIG. 7 corresponds only to the residual decoding, including inverse transforms (spatial and RCT), dequantization, and entropy decoding modules. Prediction and motion compensation are done in the raw RGB domain and are not depicted in FIG. 7.

At block 701, a bitstream is entropy decoded by an entropy decoder to form 2nd-level G coefficients at 702 and YCoCg coefficients at 707. The 2nd-level G coefficients are dequantized at 703 and two 4×4 inverse transforms are performed at 704 to form two 2nd-level 4×4 G residuals at 705.

The YCoCg coefficients at 707 are dequantized at 708 and 4×4 inverse transformed at 709 to form YCoCg-based data. At 710 the YCoCg-based data are converted to RGB-based data including a reconstructed 4×4 B residual at 711, a reconstructed 4×4 R residual at 712, and a reconstructed 4×4 G residual at 713. The reconstructed 4×4 G residual is up-sampled at 714 to form two interleaved 4×4 G residual predictions at 715.

At 706, the two 2nd-level 4×4 G residuals (at 705) are summed with the two interleaved 4×4 G residual predictions (at 715) to form two reconstructed 4×4 G residuals at 716.

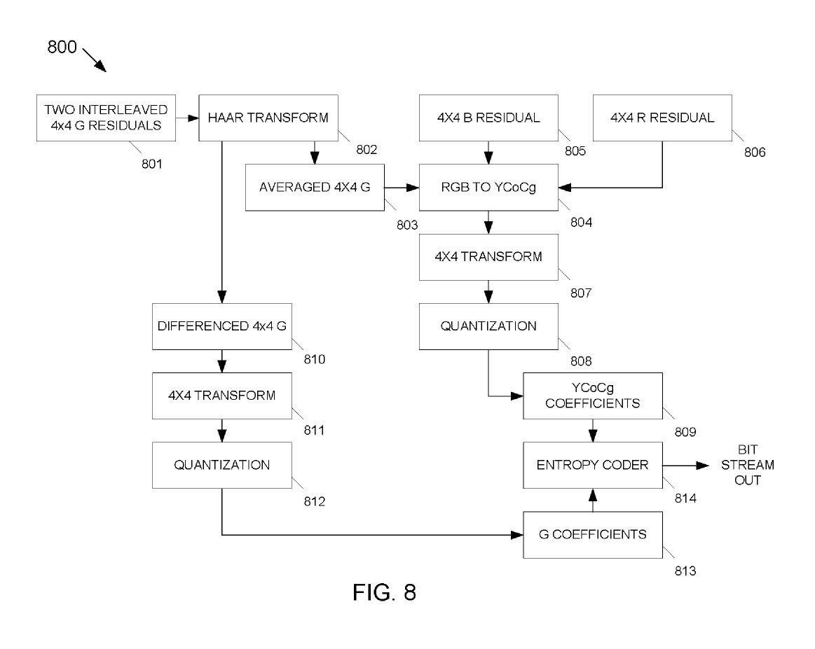

The coding of G samples described in connection with FIG. 6 is a closed-loop technique. FIG. 8 shows a flow diagram 800 of an open-loop residual encoding technique using RCT for raw RGB data according to the present invention. Block 801 in FIG. 8 represents two interleaved 4×4 blocks of Green (G) prediction residuals, similar to block 601 in FIG. 6. At 802, the two interleaved 4×4 blocks of G residuals are Haar transformed to form an averaged 4×4 G residual at 803 and a differenced 4×4 G residual at 810. The averaged 4×4 G residual at 803 is a simple average of the two closest G pixels in the two interleaved 4×4 G residuals. At block 804, the averaged 4×4 G residual together with the 4×4 Blue (B) residual (block 805) and the 4×4 block of Red (R) residual (block 806) are converted from RGB-based data to YCoCg-based data. At block 807, the YCoCg data goes through a 4×4 transformation and is quantized at block 808 to produce YCoCg coefficients at block 809. The YCoCg coefficients are coded into a bitstream by an entropy encoder at block 814.

Returning to block 802, the difference of the two 4×4 interleaved G residuals is used for form a differenced 4×4 G residual block at 810, which goes through the second-level of residual coding, that is, a 4×4 transform at 811 and quantization at 812 that are similar to steps 617 and 618 in FIG. 6, except that only one 4×4 data block need to be transformed and quantized here. The G coefficients at 813 are coded into bitstreams by the entropy coder at block 814. Blocks 610-616 of FIG. 6 are not needed in the open-loop approach of FIG. 8 because the reconstructed pixels are not needed.

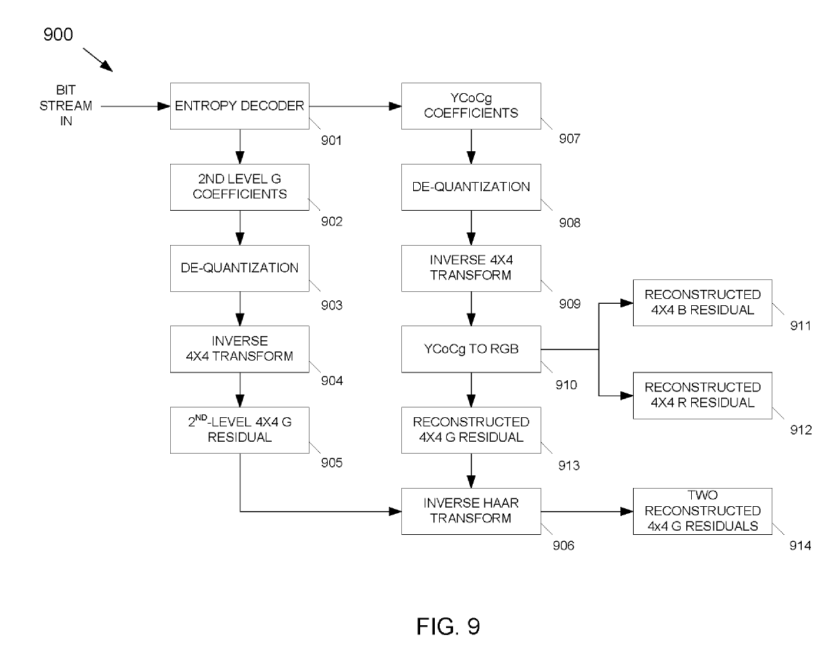

FIG. 9 shows a flow diagram 900 of an open-loop residual decoding technique using RCT for raw RGB data according to the present invention, which is a decoder corresponding to the residual encoding technique of FIG. 8. The process depicted in FIG. 9 corresponds only to the residual decoding, including inverse transforms (spatial and RCT), dequantization, and entropy decoding modules. Prediction and motion compensation are done in the raw RGB domain and are not depicted in FIG. 9.

At block 901, a bitstream is entropy decoded by an entropy decoder to form 2nd-level G coefficients at 902 and YCoCg coefficients at 907. The 2nd level G coefficients are dequantized at 903 and 4×4 inverse transformed at 904 to form a 2nd-level 4×4 G residual at 905.

The YCoCg coefficients at 907 are dequantized at 908 and 4×4 inverse transformed at 909. At 910 the YCoCg-based data are converted to RGB-based data including a reconstructed 4×4 B residual at 911, a reconstructed 4×4 R residual at 912, and a reconstructed 4×4 G residual at 913.

At 906, the 2nd-level 4×4 G residual (at 905) are inverse Haar transformed with the reconstructed 4×4 G residual (at 913) to form two interleaved reconstructed 4×4 G residuals at 914.

There are several considerations that should be kept in mind when a codec is designed for use with the present invention. For example, because the sub-sampling process at block 602 and the up-sampling process at block 614 in FIG. 6 are a normative part of a codec, symbols encoded into the bitstream are required at the sequence/picture level so that the correct up-sampling and sub-sampling are selected.

Another consideration would be that for coefficient coding, there are four total components that require coding: Y, Co, Cg, and the 2nd-level G. Separate Quantization Parameter (QP) values should be defined for each of the four components. In particular, the QPs for Y and for the 2nd-level G could be different. Coded block patterns (cbp) parameters should similarly be defined for each of the four components. Yet another consideration would be that for R/B intra prediction, 4×4 intra prediction modes are preferred; while for G, two 4×4 intra modes could be used. Alternatively, a set of intra prediction modes could be developed.

The G pixels are sampled in a quincunx pattern. Consequently, sub-pixel interpolation for motion prediction for G residuals is different from sub-pixel interpolation for motion prediction for the R or B pixels, which are sampled in a usual grid pattern. Accordingly, there are many possible interpolation methods designed for a quincunx pattern that could be used.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A Residual Color Transform (RCT) coding method for encoding Red-Green-Blue (RGB) data comprising video coding raw RGB data using an RCT coding tool.

2. The method according to claim 1, wherein video coding raw RGB data encodes the raw RGB data directly without first performing a color transform.

3. The method according to claim 1, wherein the coding method is a closed-loop coding technique.

4. The method according to claim 3, further comprising:
subsampling two interleaved 4×4 Green residuals to form a single 4×4 Green residual;
converting the single 4×4 Green residual, a corresponding 4×4 Red residual and a corresponding 4×4 Blue residual to YCoCg-based data;
4×4 transforming the YCoCg-based data;
quantizing the 4×4 transformed YCoCg-based data to form quantized YCoCg coefficients; and
coding the quantized YCoCg coefficients into a bitstream.

5. The method according to claim 4, wherein coding the YCoCg coefficients into the bitstream further includes:
dequantizing the quantized YCoCg coefficients;
4×4 inverse transforming the dequantized YCoCg coefficients to reconstruct the YCoCb-based data;
converting the YCoCg-based data to RGB-based data;
reconstructing 4×4 G residual data;
up-sampling the 4×4 G residual data to form two 4×4 G residual predictions;
forming two 2nd-level 4×4 Green residuals based on a difference between the two interleaved 4×4 G residual predictions and the two 4×4 Green residuals;
4×4 transforming the two 2nd-level 4×4 Green residuals;
quantizing the two transformed 2nd-level 4×4 Green residuals to form Green coefficients; and
coding the Green coefficients into the bitstream.

6. The method according to claim 5, further comprising:
decoding the bitstream to form YCoCg coefficients;
de-quantizing the YCoCg coefficients to form de-quantized YCoCg coefficients;
inverse-transforming the de-quantized YCoCg coefficients to form YCoCg-based data;
YCoCg-to-RGB converting the YCoCg-based data to form a reconstructed 4×4 Green residual, a corresponding reconstructed 4×4 Red residual and a corresponding reconstructed 4×4 Blue residual;
up-sampling the reconstructed 4×4 Green residual; and
forming two interleaved reconstructed 4×4 Green residual predictions.

7. The method according to claim 6, wherein forming two interleaved reconstructed 4×4 Green residual predictions includes:
decoding the bitstream to form 2nd-level Green coefficients;
de-quantizing the 2nd-level Green coefficients to form de-quantized 2nd-level Green coefficients;
inverse-transforming the de-quantized 2nd-level Green coefficients to form two 2nd-level 4×4 Green residuals; and
combining the two 2nd-level 4×4 Green residuals with the two 4×4 Green residual predictions to form the two reconstructed 4×4 Green residuals.

8. The method according to claim 1, wherein the coding method is an open-loop coding technique.

9. The method according to claim 8, further comprising:
Haar transforming two interleaved 4×4 blocks of Green prediction residuals to form an averaged 4×4 G residual and a differenced 4×4 G residual;
converting the averaged 4×4 Green residual, a corresponding 4×4 Red residual and a corresponding 4×4 Blue residual to YCoCg-based data;
4×4 transforming the YCoCg-based data;
quantizing the 4×4 transformed YCoCg-based data to form YCoCg coefficients; and
coding the YCoCg coefficients into a bitstream.

10. The method according to claim 9, wherein coding the YCoCg coefficients into the bitstream further includes:
4×4 transforming the differenced 4×4 G residual;
quantizing the transformed differenced 4×4 G residual to form Green coefficients; and
coding the Green coefficients into the bitstream.

11. The method according to claim 10, further comprising:
decoding the bitstream to form YCoCg coefficients;
de-quantizing the YCoCg coefficients to form de-quantized YCoCg coefficients;
inverse-transforming the de-quantized YCoCg coefficients to form YCoCg-based data; and
YCoCg-to-RGB converting the YCoCg-based data to form a reconstructed 4×4 Green residual, a corresponding reconstructed 4×4 Red residual and a corresponding reconstructed 4×4 Blue residual.

12. The method according to claim 11, wherein forming two reconstructed 4×4 Green residuals includes:
decoding the bitstream to form 2nd-level Green coefficients;
de-quantizing the 2nd-level Green coefficients to form de-quantized 2nd-level Green coefficients;
inverse-transforming the de-quantized 2nd-level Green coefficients to form a 2nd-level 4×4 Green residual; and
inverse-Haar transforming the 2nd-level 4×4 Green residual with the reconstructed 4×4 Green residual to form the two reconstructed 4×4 Green residuals.

13. The method according to claim 1, further comprising: directly decoding the encoded raw RGB data; and
interpolating the decoded raw RGB data for generating at least one of a missing Red color component, a missing Green color component and a missing Blue color component.

14. A video coding system directly coding raw RGB data using a RCT coding tool.

15. The system according to claim 14, wherein the system encodes the raw RGB data directly without first performing a color transform.

16. The system according to claim 14, wherein the video coding system performs a closed-loop coding technique.

17. The system according to claim 16, further comprising:
a sub-sampler sub-sampling two 4×4 Green residuals to form a single 4×4 Green residual;
a converter converting the single 4×4 Green residual, a corresponding 4×4 Red residual and a corresponding 4×4 Blue residual to YCoCg-based data;
a 4×4 transformer 4×4 transforming the YCoCg-based data;
a quantizer quantizing the 4×4 transformed YCoCg-based data to form quantized YCoCg coefficients; and
an entropy coder coding the quantized YCoCg coefficients into a bitstream.

18. The system according to claim 17, further comprising:
a dequantizer dequantizing the quantized YCoCg coefficients;
an inverse 4×4 transformer inverse 4×4 transforming the dequantized YCoCg coefficients to reconstruct the YCoCb-based data;
a YCoCg-to-RGB converter converting the YCoCg-based data to RGB-based data including a reconstructed 4×4 G residual;
an up-sampler up-sampling the reconstructed 4×4 G residual to form two 4×4 G residual predictions;
a differencer forming two 2nd-level 4×4 Green residuals based on a difference between the two 4×4 G residual predictions and the two 4×4 Green residuals;
a second 4×4 transformer 4×4 transforming the two 2nd-level 4×4 Green residuals; and
a second quantizer quantizing the two transformed 2nd-level 4×4 Green residuals to form quantized Green coefficients, and
wherein the entropy coder further codes the Green coefficients into the bitstream.

19. The system according to claim 18, further comprising a decoder that includes:
an entropy decoder decoding the bitstream to form YCoCg coefficients;
a first de-quantizer de-quantizing the YCoCg coefficients to form de-quantized YCoCg coefficients;
an inverse-transformer inverse-transforming the de-quantized YCoCg coefficients to form YCoCg-based data;
a YCoCg-to-RGB converter converting the YCoCg-based data to form a reconstructed 4×4 Green residual, a corresponding reconstructed 4×4 Red residual and a corresponding reconstructed 4×4 Blue residual; and
an up-sampler up-sampling the reconstructed 4×4 Green residual to form two reconstructed 4×4 Green residual predictions.

20. The system according to claim 19, wherein the entropy decoder decodes the bitstream to form 2nd-level Green coefficients, and
wherein the decoder further includes:
a second de-quantizer de-quantizing the 2nd-level Green coefficients to form de-quantized 2nd-level Green coefficients; and
a second inverse transformer inverse-transforming the de-quantized 2nd-level Green coefficients to form two 2nd-level 4×4 Green residuals, and
wherein the residual former combines the two 2nd-level 4×4 Green residuals with the two 4×4 Green residual predictions to form the two reconstructed 4×4 Green residuals.

21. The system according to claim 14, wherein the video coding system performs an open-loop coding technique.

22. The system according to claim 21, further comprising:
a Haar transformer Haar transforming two interleaved 4×4 blocks of Green prediction residuals to form an averaged 4×4 G residual and a differenced 4×4 G residual;
a converter converting the averaged 4×4 Green residual, a corresponding 4×4 Red residual and a corresponding 4×4 Blue residual to YCoCg-based data;
a 4×4 transformer 4×4 transforming the YCoCg-based data;
a quantizer quantizing the 4×4 transformed YCoCg-based data to form quantized YCoCg coefficients; and
an entropy coder coding the quantized YCoCg coefficients into a bitstream.

23. The system according to claim 22, further comprising:
a second 4×4 transformer 4×4 transforming a differenced 4×4 G residual; and
a second quantizer quantizing the transformed differenced 4×4 G residual to form quantized Green coefficients,
wherein the entropy coder further codes the quantized Green coefficients into the bitstream.

24. The system according to claim 23, further comprising a decoder that includes:
an entropy decoder entropy decoding the bitstream to form YCoCg coefficients;
a first de-quantizer de-quantizing the YCoCg coefficients to form de-quantized YCoCg coefficients;
a first inverse transformer inverse-transforming the de-quantized YCoCg coefficients to form YCoCg-based data; and
a YCoCg-to-RGB converter converting the YCoCg-based data to form a reconstructed 4×4 Green residual, a corresponding reconstructed 4×4 Red residual and a corresponding reconstructed 4×4 Blue residual.

25. The system according to claim 24, wherein the entropy decoder entropy decodes the bitstream to form 2nd-level Green coefficients, and
wherein the decoder further comprises:
a second de-quantizer de-quantizing the 2nd-level Green coefficients to form de-quantized 2nd-level Green coefficients; and
a second inverse-transformer inverse-transforming the de-quantized 2nd-level Green coefficients to form a 2nd-level 4×4 Green residual, and
wherein the inverse Haar transformer inverse Haar transforms the 2nd-level Green residual and the reconstructed 4×4 Green residual to form the two reconstructed 4×4 Green residuals.

26. The system according to claim 14, further comprising: a decoder directly decoding the encoded raw RGB data; and
an interpolator interpolating the decoded raw RGB data for generating at least one of a missing Red color component, a missing Green color component and a missing Blue color component.

27. A decoder, comprising:
an entropy decoder entropy decoding a bitstream to form YCoCg coefficients, the bitstream having raw RGB data video coded using an RCT coding tool;
a first de-quantizer de-quantizing the YCoCg coefficients to form de-quantized YCoCg coefficients;
an inverse-transformer inverse-transforming the de-quantized YCoCg coefficients to form YCoCg-based data;
a YCoCg-to-RGB converter converting the YCoCg-based data to form a reconstructed 4×4 Green residual, a corresponding reconstructed 4×4 Red residual and a corresponding reconstructed 4×4 Blue residual; and
an up-sampler up-sampling the reconstructed 4×4 Green residual to form two reconstructed 4×4 Green residual predictions.

28. The decoder according to claim 27, wherein the entropy decoder entropy decodes the bitstream to form 2nd-level Green coefficients, and
wherein the decoder further includes:
a second de-quantizer de-quantizing the 2nd-level Green coefficients to form de-quantized 2nd-level Green coefficients; and
a second inverse transformer inverse-transforming the de-quantized 2nd-level Green coefficients to form two 2nd-level 4×4 Green residuals, and
wherein the residual former combines the two 2nd-level 4×4 Green residuals with the two reconstructed 4×4 Green residual predictions to form the two reconstructed 4×4 Green residuals.

29. A method of decoding a bitstream having raw RGB data video coded using an RCT coding tool, the method comprising:
entropy decoding the bitstream to form YCoCg coefficients;
de-quantizing the YCoCg coefficients to form de-quantized YCoCg coefficients;
inverse-transforming the de-quantized YCoCg coefficients to form YCoCg-based data;
YCoCg-to-RGB converting the YCoCg-based data to form a reconstructed 4×4 Green residual, a corresponding reconstructed 4×4 Red residual and a corresponding reconstructed 4×4 Blue residual; and
up-sampling the reconstructed 4×4 Green residual to form two reconstructed 4×4 Green residual predictions.

30. The method according to claim 29, further comprising:
entropy decoding the bitstream to form 2nd-level Green coefficients, and
de-quantizing the 2nd-level Green coefficients to form de-quantized 2nd-level Green coefficients; and
inverse-transforming the de-quantized 2nd-level Green coefficients to form two 2nd-level 4×4 Green residuals; and
wherein forming two reconstructed 4×4 Green residuals includes combining the two 2nd-level 4×4 Green residuals with the two reconstructed 4×4 Green residual predictions to form the two reconstructed 4×4 Green residuals.

31. A decoder, comprising:
an entropy decoder entropy decoding a bitstream to form YCoCg coefficients, the bitstream having raw RGB data video coded using an RCT coding tool;
a first de-quantizer de-quantizing the YCoCg coefficients to form de-quantized YCoCg coefficients;
a first inverse transformer inverse-transforming the de-quantized YCoCg coefficients to form YCoCg-based data; and
a YCoCg-to-RGB converter converting the YCoCg-based data to form a reconstructed 4×4 Green residual, a corresponding reconstructed 4×4 Red residual and a corresponding reconstructed 4×4 Blue residual.

32. The decoder according to claim 31, wherein the entropy decoder entropy decodes the bitstream to form 2nd-level Green coefficients, and
wherein the decoder further comprises:
a second de-quantizer de-quantizing the 2nd-level Green coefficients to form de-quantized 2nd-level Green coefficients; and
a second inverse-transformer inverse-transforming the de-quantized 2nd-level Green coefficients to form a 2nd-level 4×4 Green residual, and
wherein an inverse Haar transformer inverse Haar transforms the 2nd-level 4×4 Green residual and the reconstructed 4×4 Green residual to form the two reconstructed 4×4 Green residuals.

33. A method of decoding a bitstream having raw RGB data video coded using an RCT coding tool, the method comprising:
entropy decoding the bitstream to form YCoCg coefficients;
de-quantizing the YCoCg coefficients to form de-quantized YCoCg coefficients;
inverse-transforming the de-quantized YCoCg coefficients to form YCoCg-based data; and
YCoCg-to-RGB converting the YCoCg-based data to form a reconstructed 4×4 Green residual, a corresponding reconstructed 4×4 Red residual and a corresponding reconstructed 4×4 Blue residual.

34. The method according to claim 33, wherein forming two reconstructed 4×4 Green residuals includes:
entropy decoding the bitstream to form 2nd-level Green coefficients;
de-quantizing the 2nd-level Green coefficients to form de-quantized 2nd-level Green coefficients; and
inverse-transforming the de-quantized 2nd-level Green coefficients to form a 2nd-level 4×4 Green residual, and
wherein forming two reconstructed 4×4 Green residuals includes inverse Haar transforming the 2nd-level 4×4 Green residual with the reconstructed 4×4 Green residual to form the two reconstructed 4×4 Green residuals.
